(19) United States
(12) Patent Application Publication
(10) Pub. No.: US 2003/0010315 A1
(43) Pub. Date: Jan. 16, 2003

(54) Engine compression release brake and engine using same

(76) Inventors: Sean O. Cornell, Gridley, IL (US); Scott A. Leman, Eureka, IL (US); Ronald D. Shinogle, Peoria, IL (US)

Correspondence Address: Michael B. McNeil, Liell & McNeil Attorneys PC, P.O. Box 2417, Bloomington, IN, 47402, US

(21) Appl. No.: 09/902,337

(22) Filed: Jul. 10, 2001

(51) Int. Cl. F02D 13/04

(52) U.S. Cl. 123/321

(57) ABSTRACT

Traditional engine compression release brake systems include an engine brake that is associated with each cylinder of the engine. However, if the maximum braking horsepower required by the engine is less than that produced using all engine cylinders, the engine includes excess components. In an effort to reduce the number of engine components, and therefore increase engine robustness, the present invention includes an engine compression release brake system that provides a number of engine brakes that is less than the total number of engine cylinders.

### TECHNICAL FIELD

This invention relates generally to engine compression release brakes, and more particularly to engines having engine compression release brakes for less than all engine cylinders.

### BACKGROUND

Traditional engine compression release brake systems typically include an engine brake for each engine cylinder. One such engine compression release brake system is illustrated in U.S. Pat. No. 5,647,318 which issued to Feucht et al. on Jul. 15, 1997. In braking systems such as that disclosed in Feucht et al., the braking horsepower is varied by operating less than all of the engine brakes. However, if the maximum braking horsepower required from the system does not require engine braking using all engine cylinders, the engine includes excess components. Engineers have learned that a reduction in engine components, such as by removal of excess components, can improve the overall robustness of an engine. Therefore, it should be appreciated that an engine compression release brake system including a sufficient, but reduced, number of components would be desirable.

The present invention is directed to overcoming one or more of the problems as set forth above.

### SUMMARY OF THE INVENTION

In one aspect of the present invention, an engine includes an engine housing defining a plurality of engine cylinders. An engine compression release brake is provided for each of a portion of the engine cylinders, wherein the portion is less than all of the plurality of engine cylinders.

In another aspect of the present invention, a method of engine braking using less than all engine cylinders includes the step of attaching an engine compression release brake to an engine housing for a portion, which is less than all, of the engine cylinders. The portion of engine cylinders is then operated in a braking mode.

In yet another aspect of the present invention, an engine includes an engine housing that defines a plurality of engine cylinders. An engine compression release brake is provided for each of a portion of the engine cylinders, wherein the portion is less than all of the plurality of engine cylinders. Each engine compression release brake being operably coupled to a cam actuated exhaust valve.

### BRIEF DESCRIPTION OF THE DRAWINGS

FIG. 1 is a schematic representation of an engine including a modular engine compression release brake system according to the present invention;

FIG. 2 is a sectioned front diagrammatic view of a cylinder shown in FIG. 1; and

FIG. 3 is a sectioned side diagrammatic view of the modular engine compression release brake of FIG. 1.

### DETAILED DESCRIPTION

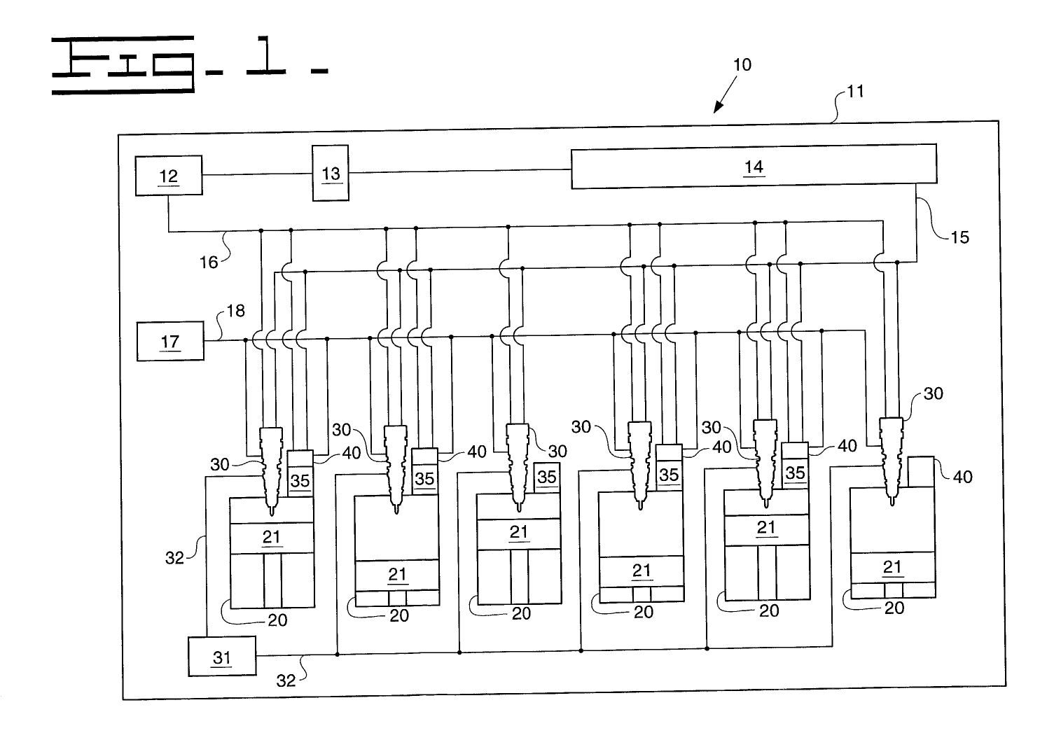

Referring now to FIG. 1 there is illustrated an engine 10 according to the present invention. A low pressure reservoir 12 is provided in engine 10 and preferably includes an amount of low pressure engine lubricating oil. While low pressure reservoir 12 is preferably an oil pan that has an amount of engine lubricating oil, it should be appreciated that other fluid sources having an amount of available fluid, such as coolant, transmission fluid, or fuel, could instead be used. A high pressure pump 13 pumps oil from low pressure reservoir 12 and delivers the same to high pressure manifold 14. High pressure oil flowing out of high pressure manifold 14 is delivered via high pressure fluid supply line 15 to a hydraulic system provided in engine 10, and used oil is returned to low pressure reservoir 12 via low pressure return line 16 after it has performed work in the hydraulic system. An electronic control module 17 is provided by engine 10 and is in control communication with one or more engine components via an electronic communication line 18. Electronic control module 17 preferably controls multiple aspects of engine 10 operation, such as fuel injection timing and engine compression release brake timing. Engine 10 also provides an engine housing 11 that defines a plurality of engine cylinders 20.

Each cylinder 20 defined by engine housing 11 has a movable piston 21. Each piston 21 is movable between a retracted, downward position and an advanced, upward position. For a typical four cycle diesel engine 10, the advancing and retracting strokes of piston 21 correspond to the four stages of engine 10 operation. When piston 21 retracts from its top dead center position to its bottom dead center position for the first time, it is undergoing its intake stroke and air can be drawn into cylinder 20 via an intake valve. When piston 21 advances from its bottom dead center position to its top dead center position for the first time it is undergoing its compression stroke and air within cylinder 20 is compressed. At around the end of the compression stroke, fuel can be injected into cylinder 20 by a fuel injector 30, and combustion within cylinder 20 can occur instantly, due to the high temperature of the compressed air. This combustion drives piston 21 downward toward its bottom dead center position, for the power stroke of piston 21. However, it is known in the art that it is not always necessary, or desirable, for injection and combustion to occur during each cycle of piston 21. Thus, for those engine cycles, engine compression release braking can occur within engine 10, as disclosed below. Finally, when piston 21 once again advances from its bottom dead center position to its top dead center position, post combustion products remaining in cylinder 20 can be vented via a cam actuated exhaust valve 35, corresponding to the exhaust stroke of piston 21. While engine 10 has been illustrated as a four cycle, six-cylinder engine, it should be appreciated that any desired number of cylinders could be defined by engine housing 11.

Each cylinder 20 is operably connected to a number of hydraulically and/or mechanically actuated devices. In addition to hydraulically actuated fuel injector 30 and cam actuated exhaust valve 35 illustrated in FIG. 1, other devices could be operably connected to each cylinder 20, such as an intake valve. Fuel injector 30 is fluidly connected to a fuel source 31 via a fuel supply line 32 and delivers fuel to cylinder 20 for combustion while exhaust valve 35 controls release of combustion remnants after each injection event. In addition, as illustrated in FIG. 1, a portion, but not all, of cylinders 20 each include a hydraulically actuated engine compression release brake 40 that is operably connected to the exhaust valve 35 for the cylinder 20. While engine 10 has been illustrated having engine compression release brakes 40 connected to four cylinders 20, it should be appreciated that engine compression release brakes 40 could instead be connected to any suitable number of engine cylinders 20 that is less than the total number of cylinders 20 defined by engine housing 11.

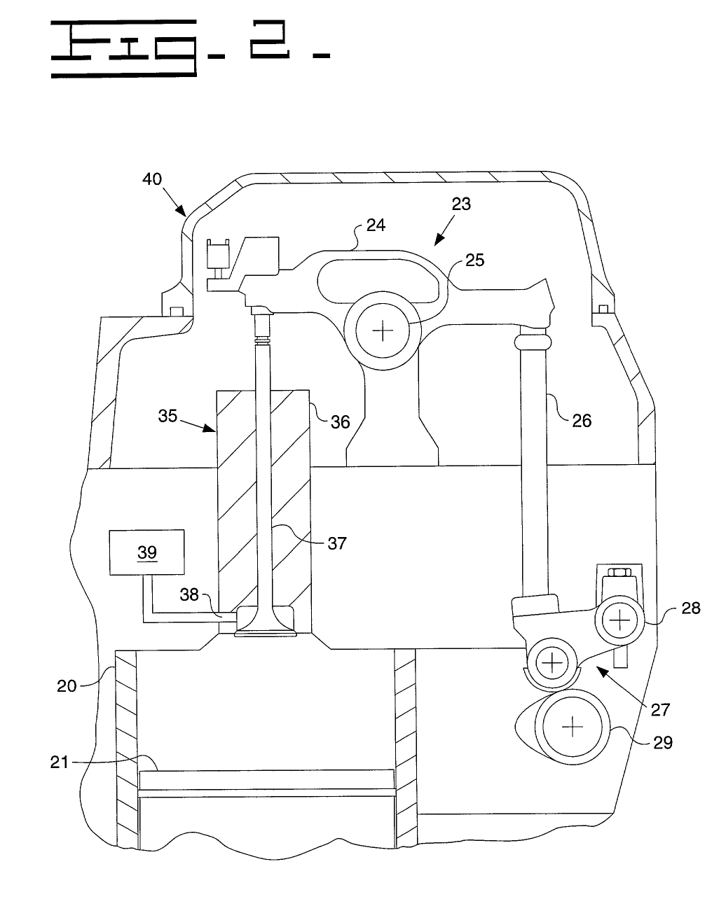

Referring now to FIG. 2, a cam 29 is provided which is positioned to mechanically engage exhaust valves 35, preferably via a rocker arm assembly 23. As cam 29 rotates, a lifter assembly 27 is moved upward about lifter group shaft 28. Lifter assembly 27 acts upon rocker arm assembly 23, which includes a rocker arm 24 mounted to pivot about pivot 25 corresponding to rotating movement of cam 29 via a connector rod 26. Thus, cam 29 can mechanically engage an exhaust valve actuator 37 movably positioned within each exhaust valve 35 via rocker arm assembly 23. With each exhaust stroke of piston 21, exhaust valve actuator 37 is driven downward to open cylinder 20 to an exhaust manifold 39 via an exhaust passage 38 defined by exhaust valve body 36. In addition, for those cylinders 20 having engine brakes 40, exhaust valve actuator 37 can also be opened during the compression stroke of piston 21 by engine brake 40, as disclosed below.

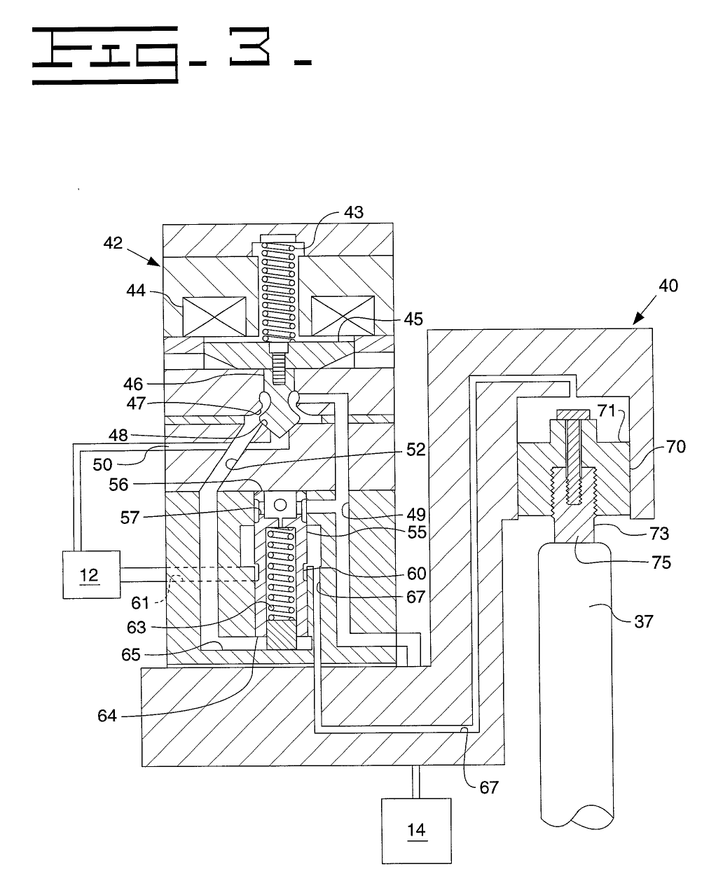

Referring in addition to FIG. 3, each engine brake 40 has a brake body 41 and provides an electrical actuator 42 that is preferably a solenoid. However, it should be appreciated that any suitable electrical actuator, such as a piezoelectric actuator, could instead be provided. Solenoid 42 includes a biasing spring 43, a coil 44 and an armature 45. Armature 45 is attached to move with a valve member 46. When solenoid 42 is de-energized, such as when engine braking is not desired, valve member 46 is biased toward its downward position by biasing spring 43. When valve member 46 is in this position, it opens a high pressure seat 47 defined by brake body 41 and closes a low pressure seat 48, also defined by brake body 41. Thus, high pressure fluid can flow around valve member 46 and into a pressure communication passage 52 from a high pressure passage 49. When solenoid 42 is energized, such as to initiate an engine braking event, valve member 46 is pulled to an upward position by armature 45 against the force of biasing spring 43. When valve member 46 is in this position, high pressure seat 47 is closed to block pressure communication passage 52 from high pressure passage 49. Low pressure seat 48 is opened such that pressure communication passage 52 is fluidly connected to a low pressure passage 50.

Also positioned in brake body 41 is a spool valve member 55 that is movable between an upward, retracted position as shown, and a downward, advanced position. Spool valve member 55 is biased toward its retracted position by a biasing spring 63. Spool valve member 55 defines a high pressure annulus 57 that is always open to high pressure passage 49 and is positioned such that it can open an actuation fluid passage 67 to high pressure passage 49 when spool valve member 55 is in its advanced position. A low pressure annulus 60 is also provided on spool valve member 55 that can connect actuation fluid passage 67 to a low pressure passage 61 defined by brake body 41 when spool valve member 55 is in its retracted position as shown. Spool valve member 55 has a control surface 64 that is exposed to fluid pressure in a spool cavity 65, and a high pressure surface 56 that is continuously exposed to high pressure in high pressure passage 44 via a number of radial passages defined by spool valve member 55. Surfaces 56 and 64 preferably are about equal in surface area, but could be different. Spool cavity 65 is fluidly connected to pressure communication passage 52.

When pressure communication passage 52 is fluidly connected to high pressure manifold 14, such as when pilot valve member 46 is in its downward position, pressure within spool cavity 65 is high and spool valve member 55 is preferably hydraulically balanced and maintained in its retracted position by biasing spring 63. When spool valve member 55 is in this position, actuation fluid passage 67 is blocked from fluid communication with high pressure passage 49 but fluidly connected to low pressure passage 61 via low pressure annulus 60. Conversely, when pressure communication passage 52 is fluidly connected to low pressure reservoir 12, such as when pilot valve member 46 is in its first position, pressure within spool cavity 65 is sufficiently low that the high pressure acting on high pressure surface 56 can to overcome the force of biasing spring 63, and spool valve member 55 can move to its advanced position. When spool valve member 55 is in this advanced position, actuation fluid passage 67 is blocked from low pressure passage 61 but high pressure fluid can flow into actuation fluid passage 67 via high pressure annulus 57 and high pressure passage 49.

As best illustrated in FIG. 3, a piston 70 is movably positioned in brake body 41 above rocker arm 24 and provides a hydraulic surface 71 that is exposed to fluid pressure in actuation fluid passage 67. In addition, a lash adjuster 73 is operably coupled to piston 70 via a lash screw 75. Lash adjuster 73 is preferably sized and positioned to provide sufficient lash to accommodate thermal expansion of the various components when engine 10 warms up, such as from a cold start. When actuation fluid passage 67 is open to low pressure passage 61, such as when engine braking is not desired, piston 70 remains in its upward, retracted position. However, when actuation fluid passage 67 is open to high pressure passage 49, high pressure acts on hydraulic surface 71 to move piston 70 toward its downward, advanced position. When piston 70 advances, lash screw 75 comes into contact with exhaust valve actuator 37 and exerts a downward force on an exhaust valve actuator 37, causing the same to move to an open position against the pressure in cylinder 20.

Industrial Applicability

Prior to the intake stroke for cylinder 20, electronic control module 17 has determined if engine braking, rather than fuel injection, is desirable from one or more cylinders 20. Once it has been determined that engine braking is desirable, a determination is made by electronic control module 17 regarding how much braking horsepower is required. Thus, electronic control module 17 will determine if all cylinders 20 having engine brakes 40 should be operated in a braking mode. Recall, however, that engine 10 according to the present invention provides for a number of cylinders 20 having engine brakes 40 that is less than all engine cylinders 20. Thus, regardless of the desired braking horsepower a number of cylinders, two for engine 10 as illustrated in FIG. 1, will not be capable of being placed in an engine braking mode. Instead, each cylinder 20 not having an engine brake 40 will under go typical intake and compression strokes of piston 21 during engine braking, but with no fuel injection from fuel injector 30. Finally, each of the cylinders 20 not having an engine brake 40 can undergo a typical exhaust stroke of piston 21, wherein exhaust valve 35 is opened by rocker arm.

For illustrative purposes, the operation of only one engine brake 40, and its respective cylinder 20, will be described. However, it should be appreciated that each engine brake 40 will operate in a similar manner. Prior to activation of engine brake 40, solenoid 42 is de-energized such that pilot valve member 46 is in its downward position opening pressure communication passage 52 to high pressure passage 49. Spool valve member 55 is in its retracted position opening actuation fluid passage 67 to low pressure passage 61 and piston 70 and plunger 75 are in their retracted positions. As piston 20 is retracting for its intake stroke, an amount of air is introduced into cylinder 20 via an intake valve (not shown). As piston 21 reaches its bottom dead center position and begins to advance, air within cylinder 20 is compressed. During typical diesel engine operation, when cylinder 20 was operating in a power mode, fuel would be injected into cylinder 20 at some point during the compression stroke of piston 21. For instance, for a traditional engine 10, fuel injection would occur as piston 21 nears the top dead center position for its compression stroke. Conversely, for a homogeneous charge compression engine, fuel injection would occur much sooner during the advance of piston 21, such as when piston 21 is closer to its bottom dead center position than its top dead center position. However, when cylinder 20 is to be operated in a braking mode, engine brake 40 is activated by electronic control module 17 during the compression stroke of piston 21.

Just prior to the start of engine braking by cylinder 20, solenoid 42 is activated by electronic control module 17 and armature 45 pulls poppet valve member 46 upward against the force of biasing spring 43 to close high pressure seat 47. Pressure communication passage 52 is now blocked from high pressure passage 49 and fluidly connected to low pressure passage 50. With low pressure fluid acting on control surface 64 in spool cavity 65 via pressure communication passage 52, the high pressure acting on high pressure surface 56 is now sufficient to move spool valve member 55 downward toward its advanced position against the force of biasing spring 63. Actuation fluid passage 67 is now blocked from low pressure passage 61 and opened to high pressure passage 49 via high pressure annulus 57. High pressure in actuation fluid passage 67 acts on hydraulic surface 71 to move piston 70 downward toward its advanced position. As piston 70 advances, lash screw 75 comes into contact with exhaust valve actuator 37, which is pushed toward its open position against the pressure in cylinder 20. Compressed air within cylinder 20 can now be vented via exhaust valve 35.

Once engine brake 40 has been activated for a sufficient amount of time to provide the desired engine braking, electrical actuator 42 is de-energized. Pilot valve member 46 is returned to its biased position opening high pressure seat 47 by biasing spring 43. Pressure communication passage 52 is now blocked from low pressure passage 50 and opened to high pressure passage 49. With high pressure again acting on control surface 64 in spool cavity 65, spool valve member 55 is once again hydraulically balanced, and is returned to its retracted position by biasing spring 63. Actuation fluid passage 67 is again blocked from high pressure passage 49 and reopened to low pressure passage 61 via low pressure annulus 60. With low pressure acting on hydraulic surface 71, piston 70 is returned to its upward, retracted position, allowing exhaust valve actuator 37 to close under the force of biasing spring 71 and the pressure within cylinder 20. While the various components of engine brake 40 reset themselves, piston 21 continues its reciprocating movement. Piston 21 retracts for its power stroke and then advances for its exhaust stroke. Exhaust valve actuator 37 is reopened by rocker arm to allow removal of the contents of cylinder 20 via exhaust valve 35.

It should be appreciated that a number of modifications could be made to the present invention. For instance, the poppet and spool valve assembly of engine brake 40 could be positioned above piston 70, as opposed to the orientation that has been illustrated herein. However, it should be appreciated that the disclosed orientation would find particular applicability where height of engine brake 40 is a concern or limitation. In addition, while engine brake 40 has been illustrated with piston 70 positioned above rocker arm 24, such that it contacts exhaust valve actuator 37 to move the same to an open position for engine braking, it should be appreciated that alternate orientations are possible. For instance, engine brake 40 could be positioned such that piston 70 is positioned below rocker arm 24 and is capable of lifting rocker arm 24 to an upward position in which exhaust valve actuator 37 is opened for engine braking. It should be appreciated, however, that for this embodiment, modifications to rocker arm assembly 23 might be desirable to prevent rocker arm 24 from disconnecting from connector rod 26 when rocker arm 24 moves independent of cam 29. Further, while the present invention has been illustrated having four engine brakes 40 utilized with a six cylinder engine 10, it should be appreciated that it could be used with an engine having any number of cylinders and could include any number of engine brakes that is less than the total number of cylinders and that is capable of providing sufficient engine braking horsepower for engine 10.

In addition to the above listed modifications, it should be appreciated that any suitable compression release brake structure having, or being modifiable to include, modular characteristics could be substituted for the hydraulically actuated brake that has been illustrated. In addition, the compression release brake could be separate from the exhaust valve, and instead utilize a separate valve member. Indeed, the modularity of the present invention can allow customers to choose, and only pay for, the amount of braking horsepower they desire for a specific application.

It should be understood that the above description is intended for illustrative purposes only, and is not intended to limit the scope of the present invention in any way. Thus, those skilled in the art will appreciate that other aspects, objects and advantages of this invention can be obtained from a study of the drawings, the disclosure and the appended claims.

What is claimed is:

1. An engine comprising:
an engine housing defining a plurality of engine cylinders; and
an engine compression release brake for each of a portion of said engine cylinders, wherein said portion is less than all of said plurality of engine cylinders.

2. The engine of claim 1 wherein each of said engine compression release brakes are alternatively fluidly connected to a source of high pressure fluid and a low pressure reservoir.

3. The engine of claim 1 wherein each said engine compression release brake includes an electrical actuator.

4. The engine of claim 1 including a cam actuated exhaust valve for each said engine cylinder.

5. The engine of claim 4 wherein each said engine compression release brake includes a hydraulic piston operably coupled to an exhaust valve actuator movably positioned in said exhaust valve.

6. The engine of claim 5 wherein a lash adjuster is operably coupled to said hydraulic piston.

7. The engine of claim 1 wherein each said engine compression release brake includes at least one valve member.

8. The engine of claim 7 wherein said at least one valve member includes a spool valve member; and
said spool valve member includes a first hydraulic surface positioned in opposition to a second hydraulic surface.

9. A method of engine braking using less than all engine cylinders, comprising the steps of:
attaching an engine compression release brake to an engine housing for each of a portion, which is less than all, of said engine cylinders; and
operating each of said portion of engine cylinders in a braking mode.

10. The method of claim 9 wherein said step of operating said portion of said engine cylinders in a braking mode includes a step exposing a hydraulic surface of a piston to high pressure actuation fluid.

11. The method of claim 9 wherein said step of operating said portion of said engine cylinders in a braking mode includes a step of energizing at least one electrical actuator that is operably coupled to said engine compression release brake.

12. The method of claim 9 wherein said step of operating said portion of said engine cylinders in a braking mode includes the steps of:
operably coupling each said engine compression release brake to an exhaust valve actuator; and
moving said exhaust valve actuator to an open position.

13. The method of claim 9 wherein said step of operating said portion of said engine cylinders in a braking mode includes a step of exposing a control hydraulic surface of a valve member to low pressure.

14. An engine comprising:
an engine housing defining a plurality of engine cylinders;
an engine compression release brake attached to said engine housing for each of a portion of said engine cylinders, wherein said portion is less than all of said plurality of engine cylinders; and
each said engine compression release brake being operably coupled to a cam actuated exhaust valve.

15. The engine of claim 14 wherein each said engine compression release brake includes a valve member having at least one hydraulic surface.

16. The engine of claim 14 wherein each said engine compression release brake includes a hydraulic piston operably coupled to an exhaust valve actuator movably positioned in said cam actuated exhaust valve.

17. The engine of claim 14 wherein a lash adjuster is operably coupled to said hydraulic piston.

18. The engine of claim 14 wherein each of said engine compression release brakes are alternatively fluidly connected to a source of high pressure fluid and a low pressure reservoir.

19. The engine of claim 14 wherein each said engine compression release brake includes at least one valve member.

20. The engine of claim 19 wherein said at least one valve member includes a spool valve member; and
said spool valve member includes a first hydraulic surface positioned in opposition to a second hydraulic surface.
